(19) United States
(12) Patent Application Publication
(10) Pub. No.: US 2007/0061277 A1
(43) Pub. Date: Mar. 15, 2007

(54) Method, system, and storage medium for providing dynamic deployment of grid services over a computer network

(75) Inventors: Edward B. Boden, Highland, NY (US); Robert C. Hansen, Johnson City, NY (US); Frank V. Paxhia, Salt Point, NY (US); Michael D. Williams, Newark Valley, NY (US)

Correspondence Address: Philmore H. Colburn II;CANTOR COLBURN LLP, 55 Griffin Road South, Bloomfield, CT, 06002, US

(73) Assignee: International Business Machines Corporation, Armonk, NY (US)

(21) Appl. No.: 10/656,985

(22) Filed: Sep. 5, 2003

(51) Int. Cl. G06F 7/00

(52) U.S. Cl. 707/1

(57) ABSTRACT

An exemplary embodiment of the invention relates to a method, system, and storage medium for providing dynamic deployment of grid services over a computer network. The method comprises installing grid artifacts in a directory located on a target hosting environment in response to an invocation of an implementation of a deployment grid service. The grid artifacts include a Web service deployment descriptor, a service implementation, and a WSDL describing the service implementation. The method also includes providing addressability of the grid service to the client system by updating the Web service deployment descriptor with service data elements and typemappings associated with the client system. The artifacts are resident in a GAR file provided by a grid services deployment system. Other embodiments include a system and a storage medium.

### BACKGROUND

The present invention relates generally to web services, and more particularly, the invention relates to a method, system, and storage medium for providing dynamic deployment of grid services over a computer network.

Web services include independently operated applications that are implemented over the Internet and which allow disparate systems to interact via common specifications and protocols. Existing Web services are still in their infancy stage. To date, there is no universally-accepted standard that would allow business enterprises to realize the full potential of Web services.

One type of Web service that is breaking ground is grid computing which involves bringing together numbers of heterogeneous computing devices resulting in a virtual organization (VO) whereby processing cycles and other resources can be shared for implementing complex functions.

The Open Grid Services Architecture (OGSA) is a grid system architecture based on an integration of Grid and Web services concepts and technologies. It includes a community-based set of services and software libraries for providing security, information infrastructure, resource management, data management, communication, fault detection, and portability functions. OSGA utilizes Web Services Description Language (WSDL), an XML-formatted language, to describe a Web service's capabilities for exchanging messages. OGSA includes WSDL interfaces, conventions, and service bindings that define the components required for creating complex distributed systems, such as lifetime management, change management, and notification, as well as for supporting security features. Utilizing WSDL, the OSGA architecture defines extensions to web services that specify properties for grid applications. These extensions, and their definitions in the OSGA specification, seek to provide a standard for technology such as portType relationships and serviceData in order to ensure interoperability among running grid services.

The irony of OSGA is that, although meant to address a dynamic, distributed, on demand, ‘utility’ style of computing (i.e., grid computing), no provision is made for dynamically deploying these underlying grid services. That is, due to their being web services, the OSGI runtime environment itself, and any additional grid services an instance contains, must all be deployed using preexisting web services tools and concepts. Thus, adding and removing grid services is done using web service techniques. Among other problems, this typically requires stopping the web server, running various web service deployment tools and scripts, then restarting the web server testing, and putting it back into production. This solution is slow, error prone, and very undesirable.

What is needed, therefore, is a way to improve the web service by defining a grid service that can enable dynamic deployment and undeployment of grid services.

### SUMMARY

An exemplary embodiment of the invention relates to a method, system, and storage medium for providing dynamic deployment of grid services over a computer network. The method comprises installing grid artifacts in a directory located on a target hosting environment in response to an invocation of an implementation of a deployment grid service. The grid artifacts include a Web service deployment descriptor, a service implementation, and a WSDL describing the service implementation. The method also includes providing addressability of the grid service to the client system by updating the Web service deployment descriptor with service data elements and typemappings associated with the client system. The artifacts are resident in a GAR file provided by a grid services deployment system. Other embodiments include a system and a storage medium.

### BRIEF DESCRIPTION OF THE DRAWINGS

Referring now to the drawings wherein like elements are numbered alike in the several FIGURES:

FIG. 1 is a block diagram of a system upon which the grid services deployment system is implemented in an exemplary embodiment;

FIG. 2 is a flowchart describing the process of implementing the grid services deployment system in an exemplary embodiment;

FIG. 3 is a flowchart describing the process of implementing the undeploy function of the grid services deployment system in an exemplary embodiment; and

FIG. 4 is a user interface screen seen by a user of the grid services deployment system for which the user can access to temporarily deploy a grid service or deploy a new version of an existing grid service in an exemplary embodiment.

### DETAILED DESCRIPTION OF A PREFERRED EMBODIMENT

OSGA facilitates grid services by providing a set of well-defined interfaces and by following specific conventions. The interfaces address discovery, dynamic service creation, lifetime management, notification, and manageability; the conventions address naming. Grid services also address authorization and concurrency control. This core set of interfaces facilitates the construction of hierarchical, higher-order services that can be treated uniformly across layers of abstraction.

A portType is an interface that defines a grid service. A portType inheritance allows the interfaces described using WSDL portType definitions to be aggregated via inheritance; that is, a portType may inherit operations and definitions from other portTypes. A serviceType defines the collection of portTypes that a Grid service supports along with some additional information relating to versioning. Associated with each interface is a set of service data elements that provide a standard representation for information about Grid service instances. Service data refers to OGSI-defined extensibility elements within WSDL portTypes to define data and data types using XML and XML schema syntax. This data and associated type information is used to expose the detailed state information associated with the service at runtime. A user can implement a particular Grid service as defined by its interfaces and associated service data elements and host it in different environments.

Grid services can maintain internal state for their lifetime. The existence of state distinguishes one instance of a service from another instance that provides the same interface. The term Grid service instance refers to a particular instantiation of a Grid service.

Because Grid services are dynamic and stateful, they must be distinguished from one another. This is accomplished via a globally unique name, the Grid service handle.

OGSA defines the semantics of a Grid service instance: how it is created and named, has its lifetime determined, and communication protocols selected. OGSA does not, however, place requirements on what a service does or how it performs that service. OGSA does not address issues such as the implementation programming model, programming language, implementation tools, or execution environment. A specific execution or hosting environment instantiates Grid services. A hosting environment defines not only the implementation programming model, programming language, development tools, and debugging tools, but also how a Grid service implementation meets it obligations with respect to Grid service semantics. Container- or component-based hosting environments such as J2EE, Websphere, .NET, and Sun ONE can implement Web services such as a grid service and offer superior programmability, manageability, flexibility, and safety. A container has primary responsibility for ensuring that the services it supports adhere to Grid service semantics and for offloading some service responsibilities from the service implementer.

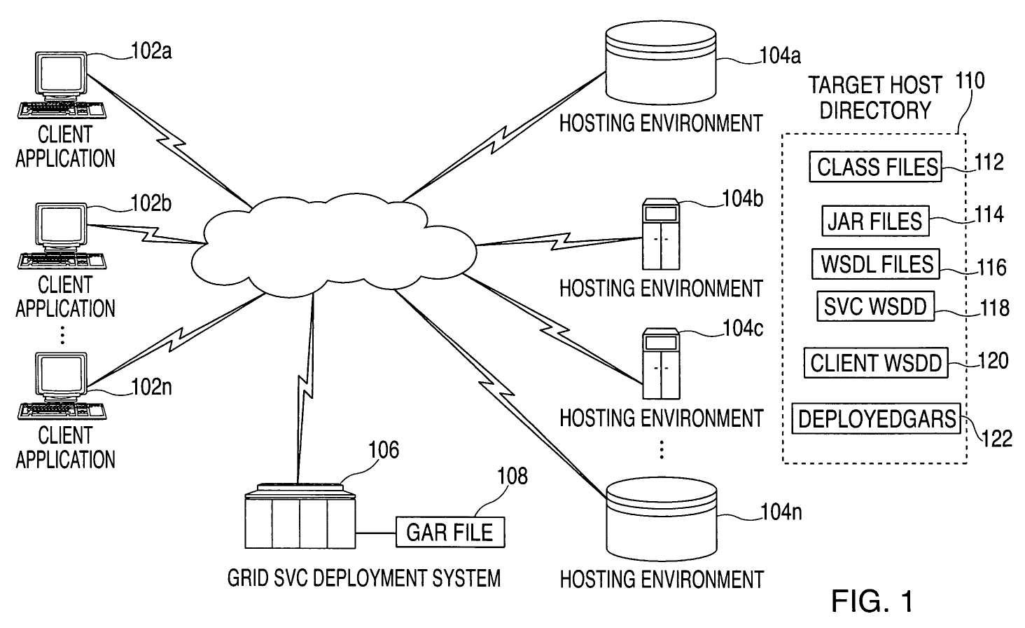

Referring to FIG. 1, client systems 102a-102n execute client applications including requests for grid services. Client systems 102a-102n each comprise a web-enabled processing device such as a general purpose computer, laptop or mobile computing instrument and execute various client applications such as word processing, spreadsheet, analytical, or other similar types software programs known in the art. Although not shown, client systems 102a-102n may be part of a larger network of computer devices and connected via suitable networking infrastructures and technologies such as Intranet, Wide Area Network, and wireless Wi-Fi technologies. For purposes of illustration and simplification, client systems 102a-102n are stand alone, independent entities connected to the Internet.

Host system 106 executes the grid service deployment system in response to requests from one or more of client systems 102a-102n. Host system 106 may be an application service provider (ASP) for grid services, an e-utilities broker, or other semantically equivalent provider of services. Host system 106 may comprise a mainframe or other high speed processor and includes server software. In an alternative embodiment, one or more of client systems 102a-102n or hosting environment systems 104a-104n may implement the grid services deployment system. The grid service deployment system utilizes a GAR file 108 as described herein. A GAR file, also referred to as grid service archive, is a file-based container that holds the various artifacts that are needed to install and deploy one or more services. This provides a convenient mechanism for distributing these artifacts together as a style bundle.

Hosting environment systems 104a-104n are providers of grid services. For example, hosting environments 104a and 104n represent data storage/archival services while hosting environments 104b and 104c provide processor resources to client systems 102a-102n. Types of services can range from content providers, data mining activities, or other similar type of services.

The hosting environment selected by the grid service deployment system in response to request from one of client systems 102a-102n is referred to herein as the target hosting environment. The target hosting environment includes a target host directory (also referred to as “directory”) 110 that stores various files in sub-directories and temporary storage located therein. These files include class files 112, jar files 114, WSDL files 116, service WSDD 118, client WSDD 120, and deployedGARS file 122. Files 112-122 store artifacts provided by host system 106 with respect to an OSGI instance. A JAR file is a Java archive file that is used to hold one or more Java related files. These are most often Java class files. A Java class file (also referred to as Java byte code) is a compiled Java file that can be interpreted by a Java Virtual Machine (JVM). WSDL files are XML files that describe a web service interface and associated XML types. WSDD files are web service deployment descriptors. These files contain the details needed by the web service container or hosting environment and that is needed to make the service addressable to client applications.

Client systems 102a-102n, host system 106, and hosting environment systems 104a-104n communicate over a networking infrastructure such as the Internet.

The grid service deployment system includes WSDL-formatted operations for dynamically deploying and undeploying a grid service. The grid service deployment system operation “Deployment service portType” defines the interface that is to be used to dynamically deploy a single grid service to an OGSI instance. The Deployment service portType comprises serviceData elements conformant to serviceData elements as described below.

```
<gsdl:serviceDataDescription
    Name=”DeploymentLogEntry”
    Type=”xsd:String”
    MinOccurs=”0”
    MaxOccurs=”unbounded”
    Mutability=”constant”
  <wsdl:documentation>
    An entry for each successful deploy and undeploy operation.
  </wsdl:documentation>
</gsdl:serviceDataDescription>
```

There are two Deployment portType operations and messages utilized by the grid service deployment system as shown below.

Deployment::deployGridService

Deployment::undeployGridService

Deployment::deployGridService deploys a new grid service to the OGSI instance in which the Deployment grid service is running. Once successfully deployed, a grid service remains deployed on the OGSI instance until explicitly undeployed via the Deployment::undeployGridService operation or via local OGSI instance configuration change. For security reasons, deployment of a grid service is only allowed by a client that successfully authenticates the OGSI-instance with administrator privileges.

Upon initiating the Deployment::deployGridService operation, a GAR file is input to the grid service deployment system along with a StartIndicator selection. A GAR file comprises, at a minimum, a class file and an implementation WSDL template, .wsdd <service> element, but may include a jar, multiple jars, etc. A StartIndicator selector is included in the operation and is used to indicate whether the grid service is to be started immediately or not via ‘yes’ or ‘no’ values. If not started immediately, the grid service will be started the next time the OGSI instance is started. The output of the deployGridService request is a grid service handle (GSH), in the format specific to the binding used to invoke the handleResolver::FindByHandle operation. Two fault messages are possible with this operation: ‘InvalidGAR’, indicating the deployment failed due to problems found with the supplied GAR file, or ‘OperationNotAuthorized’, indicating that the client is not authorized to perform the deployGridService operation.

The Deployment::undeployGridService undeploys a currently deployed grid service from the OGSI instance in which the Deployment grid service is running. It will be understood that undeployment of a grid service will have no effect on an operating instance of that grid service (if any).

The input for the Deployment::undeployGridService operation includes a GAR name; that is, the name of the deployed GAR to undeploy. A GSH could also be returned here as an alternative and would have been obtained via earlier invocation to deployGridService or GridService::findGridService. The output of the undeploy request is the Result which indicates whether the request has succeeded or failed. A fault message ‘OperationNotAuthorized’ may be used to indicate that the client is not authorized to perform the deployGridService operation.

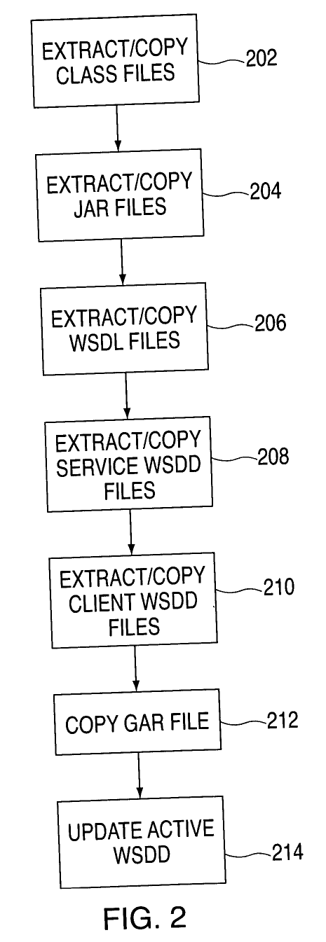

The implementation of these operations are described further in FIG. 2. The deployGridService operation has the effect of both installing the grid service artifacts into the target hosting environment and making the service addressable to client applications.

The installation component of the deployGridService operation extracts artifacts from the GAR 108 and moves them to a location or directory 110 within the target hosting environment as described herein. The grid artifacts include a Web service deployment descriptor, a service implementation; and a WSDL describing the service implementation. Upon installation, the grid service deployment system performs the service implementation by extracting Java class files and copying them to a hosting environment sub-directory 112 at step 202. Java Jar files are also extracted from the GAR and copied to a hosting environment sub-directory 114 of the target hosting environment at step 204.

WSDL files are extracted from the GAR 108 and copied to a hosting environment sub-directory 116 at step 206. Also extracted from the GAR 108 are the service Web Service Deployment Descriptors (WSDD) files which are copied to a temp directory of target hosting environment 118 at step 208. The client Web Service Deployment Descriptors (WSDD) files are extracted and copied to a temporary directory 120 at the target hosting environment at step 210. Additionally, the GAR file 108 itself is placed in a deployedGARs subdirectory 122 which enables any subsequent undeployGridService operation along with details required to successfully undeploy the service at step 212.

The addressability component of the grid service deployment system will now be described. At step 214, the Grid service is made addressable to the client application of any of client systems 102a-102n by updating the active Web Service deployment descriptor (WSDD). This includes merging the service element and sub-elements into the active WSDD as well as any XML to Java typemappings needed for XML-to-Java serialization and deserialization based upon the types defined in the service's WSDL definition. Likewise, any client XML-to-Java typemappings need to be merged into the active client WSDD in the event that the grid service itself is a client to another grid service.

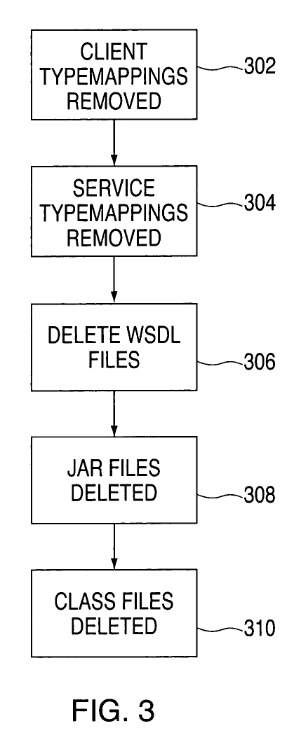

The implementation of the undeployGridService operation is described in FIG. 3. The undeployGridService reverses the steps performed by the deployGridService operation. The copy of the GAR 108 that was moved to the deployedGARS subdirectory 122 is used to perform the undeployment procedure. At step 302 client XML-to-Java typemapping elements in the GAR 108 are removed from the active client WSDD. Service and typemapping elements from the active WSDD found in the GAR 108 are removed at step 304. The WSDL files in the sub-directory 116 are deleted at step 306. The Jar files in sub-directory 114 are deleted at step 308 and Java class files from sub-directory 112 are deleted at step 310.

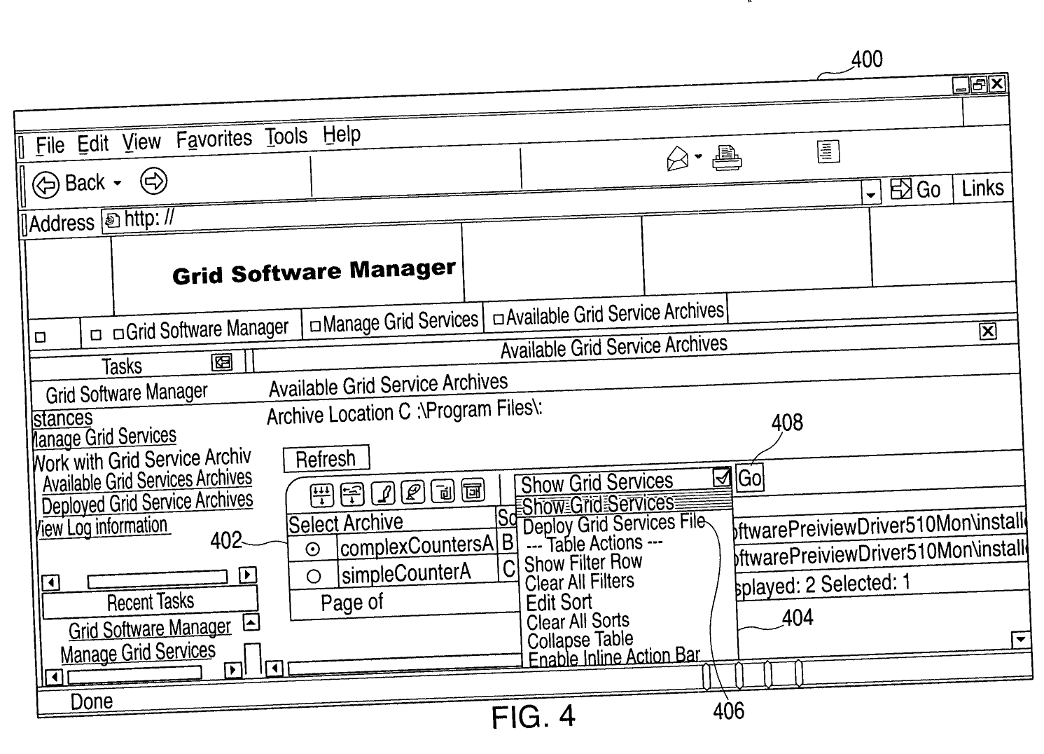

In one embodiment of the invention, a client application can utilize the deployment service client proxy to deploy an appropriately packaged grid service. As shown in FIG. 4, a user can interact with a web application that presents available grid services to be deployed. The web application preferably resides on a hosting environment. In the user interface screen 400 of FIG. 4, a user selects the grid service to be deployed 402 using a drop down list. Once the grid service is selected, the user selects “Deploy Grid Services File” option 406 from a drop down list 404, followed by “go” 408 which causes the web application of the grid service deployment system to call the deployment service client proxy with the selected grid service 402.

In an alternative embodiment, a user interface is not required in order to interact with a client proxy (not shown). Applications dynamically determine what services are required or not required on various nodes and programmatically deploy and undeploy those services. Applications may determine what services are required to complete a given task, and dynamically deploy these services to a set of nodes, and then use the deployed services to complete the task. Business logic may be used to determine the best services and locations to run those services.

In yet another embodiment, the Deploy portType operation may be used to temporarily deploy a grid service, or to deploy a new version of an existing grid service. Because the grid service is invocable by the grid services running on the OGSI instance itself, it could be used by those local grid services to expand and contract the grid services running on the OGSI instance.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for providing dynamic deployment of grid services over a computer network, comprising:
installing grid artifacts in a directory located on a target hosting environment in response to an invocation of an implementation of a deployment grid service by a client system, the target hosting environment remotely located from the client system over the computer network, said grid artifacts including:
a Web service deployment descriptor;
a service implementation; and
a WSDL describing said service implementation; and
providing addressability of said grid service to the client system over the computer network by updating said Web service deployment descriptor with service data elements and typemappings associated with said client system;
wherein said artifacts are resident in a GAR file provided by a grid services deployment system.

2. The method of claim 1, wherein installing said service implementation includes:
extracting Java class files from said GAR file;
copying said Java class files into a first subdirectory on said target hosting environment directory;
extracting Java Jar files from said GAR file; and
copying said Java jar files into a second subdirectory.

3. The method of claim 1, wherein installing said WSDL includes:
extracting WSDL files from said GAR file; and
copying said WSDL files into a third subdirectory on said target hosting environment.

4. The method of claim 1, wherein installing said Web service deployment descriptor includes:
extracting service Web Service Deployment Descriptors (WSDD) files;
copying said service WSDD files into a temporary directory of said target hosting environment directory;
extracting client Web Service Deployment Descriptors (WSDD) files; and
copying said client WSDD files to a temporary directory at said target hosting environment.

5. The method of claim 1, wherein said installing said grid artifacts in a directory further includes:
automatically copying said GAR file into a deployedGARs subdirectory in said target hosting environment directory, wherein said copying said GAR file into a deployedGARs subdirectory is operable for undeploying a grid service operation.

6. The method of claim 1, wherein said updating said Web service deployment descriptor with service data elements and typemappings associated with said client system comprises:
merging said service element and sub-elements into said active WSDD; and
merging any service XML-to-Java typemappings needed for XML-to-Java serialization and deserialization based upon said types defined in a grid service's WSDL definition; and
merging any client XML-to-Java typemappings into said active client WSDD in the event that said grid service itself is a client to another grid service.

7. The method of claim 1 wherein multiple grid services are simultaneously deployed.

8. A method for providing dynamic undeployment of grid services over a computer network, comprising:
automatically removing grid artifacts from a directory located on a target hosting environment, said grid artifacts including:
a Web service deployment descriptor;
a service implementation; and
a WSDL describing said service implementation.

9. A system for providing dynamic deployment of grid services over a computer network, comprising:
a host system in communication with at least one network-enabled client system and a target hosting environment over the computer network, the target hosting environment remotely located from the network-enabled client system, said host system operating in an OGSI architected environment; and
a grid services deployment system executing on said host system,
the grid services deployment system performing
installing grid artifacts in a directory located on the target hosting environment in response to an invocation of an implementation of a deployment grid service by the network-enabled client system, said grid artifacts including:
a Web service deployment descriptor;
a service implementation; and
a WSDL describing said service implementation; and
providing addressability of said grid service to said network-enabled client system over the computer network by updating said Web service deployment descriptor with service data elements and typemappings associated with said network-enabled client system;
wherein said artifacts are resident in a GAR file provided by a grid services deployment system.

10. The system of claim 9, further comprising a user interface implemented by the host system, the user interface operable for interacting with said at least one network-enabled client system.

11. A computer program product embodied on a computer-readable medium, the computer program product including instructions executable by a computer processor for providing dynamic deployment of grid services over a computer network, the computer program product including instructions executable by a computer processor for performing:
installing grid artifacts in a directory located on a target hosting environment in response to an invocation of an implementation of a deployment grid service by a client system, the target hosting environment remotely located from the client system over the computer network, said grid artifacts including:
a Web service deployment descriptor;
a service implementation; and
a WSDL describing said service implementation; and
providing addressability of said grid service to said client system over the computer network by updating said Web service deployment descriptor with service data elements and typemappings associated with said client system;
wherein said artifacts are resident in a GAR file provided by a grid services deployment system.

12. The computer program product of claim 11, wherein installing said service implementation includes:
extracting Java class files from said GAR file;
copying said Java class files into a first subdirectory on said target hosting environment directory;
extracting Java Jar files from said GAR file; and
copying said Java jar files into a second subdirectory.

13. The computer program product of claim 11, wherein installing said WSDL includes:
extracting WSDL files from said GAR file; and
copying said WSDL files into a third subdirectory on said target hosting environment.

14. The computer program product of claim 11, wherein installing said Web service deployment descriptor includes:
extracting service Web Service Deployment Descriptors (WSDD) files;
copying said service WSDD files into a temporary directory of said target hosting environment directory;
extracting client Web Service Deployment Descriptors (WSDD) files; and
copying said client WSDD files to a temporary directory at said target hosting environment.

15. The computer program product of claim 11, wherein said installing said grid artifacts in a directory further includes:
automatically copying said GAR file into a deployedGARs subdirectory in said target hosting environment directory, wherein said copying said GAR file into a deployedGARs subdirectory is operable for undeploying a grid service operation.

16. The computer program product of claim 11, wherein said updating said Web service deployment descriptor with service data elements and typemappings associated with said client system comprises:
merging said service element and sub-elements into said active WSDD; and
merging any service XML-to-Java typemappings needed for XML-to-Java serialization and deserialization based upon said types defined in a grid service's WSDL definition; and
merging any client XML-to-Java typemappings into said active client WSDD in the event that said grid service itself is a client to another grid service.

17. The computer program product of claim 11 wherein multiple grid services are simultaneously deployed.

18. The method of claim 7, further comprising remotely and concurrently deploying the GAR file to multiple target hosting environments over the computer network.

19. The method of claim 7, further comprising remotely and concurrently deploying multiple GAR files to corresponding multiple target hosting environments over the computer network.
